(19) United States
(12) Patent Application Publication
(10) Pub. No.: US 2001/0053284 A1
(43) Pub. Date: Dec. 20, 2001

(54) Photographing apparatus for three-dimensional image and method therefor

(76) Inventor: Kyoung-Moon Shin, Seoul (KR)

Correspondence Address: Daniel F. Drexler, 55 Griffin South Road, Bloomfield, CT, 06002, US

(21) Appl. No.: 09/754,982

(22) Filed: Jan. 5, 2001

(30) Foreign Application Priority Data
Jun. 14, 2000 (KR) 2000-32616
Nov. 1, 2000 (KR) 2000-64553

(51) Int. Cl. G03B 17/00; G03B 41/00

(52) U.S. Cl. 396/5; 396/335; 396/263

(57) ABSTRACT

A photographing apparatus and method for a three-dimensional image and an image service system and method through communications networks are provided. The photographing apparatus for a three-dimensional image has a turning means for detecting the rotation state of the turning means by angle and outputting a signal at predetermined angles; a control unit for outputting a photographing timing signal and finishing the photographing if a predetermined number of output signals from the turning means are received; and a photographing means for photographing an object according to the photographing timing signal. The image service system through communications networks has one or more image photographing means, each of which generates a three-dimensional image by photographing an object at each predetermined angle, adds user identification information to the generated three-dimensional image, and then transmits the image; and an operating means for receiving the three-dimensional images and identification information generated by the photographing means; storing the received data in a database; and if a user requests to watch the three-dimensional image, outputting the stored three-dimensional image corresponding to the user identification information, to the user computer through communications networks. A user can easily photograph a three-dimensional image, using the photographing apparatus for a three-dimensional image, having the turning means for detecting a rotation state by angle and outputting a signal. Particularly, if using the image service system through communications networks, images photographed by each photographing means are automatically transmitted to an operating means and managed in the operating means, and therefore the user can receive his three-dimensional image through communications networks any place, any time.

### BACKGROUND OF THE INVENTION

1. Field of the Invention

The present invention relates to a photographing apparatus and method for a 3-dimensional image, and an image service system and method having the photographing apparatus for a three-dimensional image and more particularly, to an image photographing device generating a three-dimensional image by linking a plurality of plane images photographed by angle and a method therefor.

2. Description of the Related Art

At present, in line with the spreading use of the Internet, there are many kinds of services provided through the Internet. Internet services are provided through Internet sites, and an Internet site is managed by a computer referred to as a web server. Internet services have an advantage of no limitations in time, space, or distance in using the services.

Meanwhile, according to the development of photograph technologies, various services using photographs are widely provided. Among the services is a photo sticker service. Photo sticker machines are placed at several locations, and a simple sticker photo can be obtained immediately in each machine. The photo sticker photographing apparatus photographs the image of a user and then prints out the image on a small sticker. Also, the scope of application services using a photo, such as a service for printing a photo on a mug or souvenir is expanding.

However, the conventional photo is two-dimensional and has a limit in satisfying users, and therefore, for more exciting and diversified services, three-dimensional moving images are desired. To get a moving image, a video camera must be used, but it is very inconvenient to carry the video camera. Also, even after filming with a video camera, the video tape and a video tape player must be prepared to watch the filmed image.

Therefore, a new system is required so that users can easily photograph three-dimensional images, and can access the images they photographed at any time in any place, using the advantage of the Internet.

### SUMMARY OF THE INVENTION

To solve the above problems, one embodiment of the present invention to provides a photographing apparatus and method for a three-dimensional image of an object.

The present invention provides an apparatus and method for providing an image service through communications network, the image service processing images, which are photographed in photographing apparatuses placed in a plurality of locations, into three-dimensional images.

To accomplish the above, there is provided in the present invention a photographing apparatus for a three-dimensional image, having a turning means for turning an object thereon, detecting the rotation state of the turning means by angle and outputting a signal at predetermined angles; a control unit for outputting a photographing timing signal and finishing the photographing if a predetermined number of output signals from the turning means are received; and a photographing means for photographing the object according to the photographing timing signal.

There is also provided in the present invention an image service system through communications networks having one or more image photographing means, each of which generates a three-dimensional image by photographing an object at each predetermined angle, adds user identification information to the generated three-dimensional image, and then transmits the image; and an operating means for receiving the three-dimensional images and identification information generated by the photographing means, storing the received data in a database, and if a user requests to watch the three-dimensional image, outputting the stored three-dimensional image corresponding to the user identification information, to the user computer through communications networks.

It is preferable that the image photographing means has a turning means for detecting the rotation state of the turning means by angle and outputting a signal at predetermined angles; a control unit for outputting a photographing timing signal and finishing the photographing if a predetermined number of output signals from the turning means are received; and a photographing means for photographing an object according to the photographing timing signal.

### BRIEF DESCRIPTION OF THE DRAWINGS

The above advantages of the present invention will become more apparent by describing in detail preferred embodiments thereof with reference to the attached drawings in which:

FIG. 1 is the structure of an embodiment of a photographing apparatus for a three-dimensional image according to the present invention;

FIG. 2A is a sectional view for illustrating the internal structure of a turning means in an embodiment of the photographing apparatus for a three-dimensional image according to the present invention;

FIG. 2B is a perspective view of the internal structure of the turning means in an embodiment of the photographing apparatus for a three-dimensional image according to the present invention;

FIG. 3 illustrates the structure of another embodiment of the photographing apparatus for a three-dimensional image according to the present invention;

FIG. 4 is a flowchart of the operation of an embodiment of the photographing apparatus for a three-dimensional image according to the present invention;

FIG. 5A is a structure of an embodiment of an image service system through communication networks according to the present invention;

FIG. 5B is a detailed structure of an embodiment of the image service system through communications networks according to the present invention;

FIG. 6 is a flowchart of the operation of an embodiment of the image service system through communications networks according to the present invention; and

FIG. 7 illustrates an embodiment of the image photographing means of the image service system through communications networks according to the present invention.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to one skilled in the art.

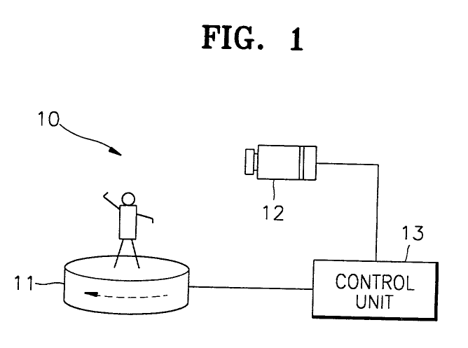

FIG. 1 is the structure of an embodiment of a photographing apparatus for a three-dimensional image according to the present invention.

Referring to FIG. 1, the photographing apparatus for a three-dimensional image 10 according to the present invention has a turning means 11 having a sensor for turning an object thereon, detecting the rotation state of the turning means by angle and outputting a signal at predetermined angles; a photographing unit 12 for photographing an object according to a predetermined photographing timing signal; and a control unit 13 for controlling the photographing unit to photograph the object by generating a photographing timing signal according to the output signal of the sensor or a predetermined time interval, and finishing the photographing by stopping the turning means if the turning means makes a predetermined number of rotations.

The object (for example, a user, puppy, etc.) is placed on the turning means 11, and the turning means 11 rotates according to a predetermined number of rotations. If a detecting signal from the sensor is input to the control unit 13 in accordance with the rotation of the turning means 11, the control unit 13 outputs a photographing timing signal to the photographing unit 12, and the photographing unit 12 intermittently photographs the object at each predetermined angle according to the photographing timing signal.

For example, the photographing unit 12 can be a digital camera or a digital camcorder. At this time, the digital camera or digital camcorder can be made to photograph the object whenever the turning means 11 rotates in a 10-degree arc, and in this case, 36 plane images obtained by photographing the object in each 10-degree arc are generated. Meanwhile, it is preferable that, according to a photographing timing signal at a predetermined time interval from the control unit 13, instead of the detecting signal input from the sensor, the photographing unit 12 photographs the object. At this time, by adjusting photographing timing signals generated in one second according to the time required for a rotation of the turning means 11, a plurality of plane images can be generated. For example, if the time required for a rotation of the turning means 11 is twelve seconds and the control unit 13 outputs three photographing timing signals per second to the photographing unit 12, then a total of thirty-six plane images can be photographed.

The control unit 13 processes the plurality of plane images photographed by the photographing unit 12 in a predetermined photographing time, to a 360-degree three-dimensional image by connecting the plane images. In this image processing, the plurality of plane images are processed to have appropriate brightness and color saturation, using an image processing software, and converted into a 360-degree three-dimensional image, using a virtual reality image processing software. At this time, for the process to convert the plurality of plane images into a 360-degree three-dimensional image, an animation method for converting a two-dimensional plane images to moving pictures can be used. This image converting process can include the processes for editing images and integrating multiple images. Meanwhile, the 360-degree three-dimensional image can be compressed, using an image compression software to transmit the image through communications networks.

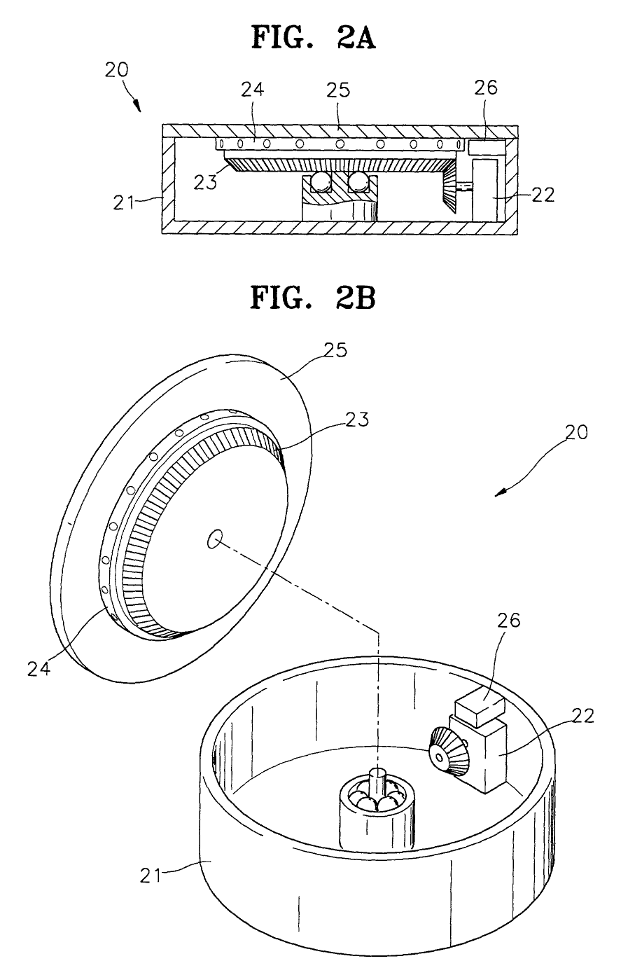

FIG. 2A is a sectional view illustrating the internal structure of the turning means in an embodiment of the photographing apparatus for a three-dimensional image according to the present invention. FIG. 2B is a perspective view of the internal structure of the turning means in an embodiment of the photographing apparatus for a three-dimensional image according to the present invention. Identical reference numbers in FIGS. 2A and 2B represent identical elements.

The turning means has a case 21 having a first rotating axis; a motor 22 having a second rotating axis and having a first worm wheel gear at an end of the second rotating axis; a second worm wheel gear 23 rotating interlocked with the first worm wheel gear installed in the motor 22, and attached to the first rotating axis; a sensor plate 24 which is fixed to the second worm wheel gear 23, rotates according to the rotation of the second worm wheel gear 23, and has a plurality of holes, which are formed at predetermined intervals, on its side; a rotation plate 25 which is fixed to the sensor plate 24 and rotates according to the rotation of the sensor plate 24; and a sensor 26 which is spatially separated from the sensor plate 24 and outputs a detecting signal by detecting a hole of the sensor plate 24.

The turning means can be manufactured so that the second worm wheel gear 23 rotates according to the rotation of the motor 22 attached to the turning means case 21, and the sensor plate 24 and the rotation plate 25 rotate according to the rotation of the second worm wheel gear 23. At this time, each of a plurality of holes is made at a predetermined interval on the side of the sensor plate 24, and when the sensor 26 detects a hole on the side of sensor plate, the sensor 26 outputs a detecting signal to the control unit 13. To photograph at each 10-degree arc an object that stands on the rotation plate 25 and rotates according to the rotation of the sensor plate 25, thirty-six holes must be made on the side of the sensor plate 24. The turning means 20 is driven and stopped by the signals from the control unit 13 and the default value of the rotation number of the turning means is set to “1”. The sensor 26 can detect holes on the side of the sensor plate 24, as an optical sensor, infrared sensor, ultraviolet sensor, etc. Also, it is preferable that a variable-speed motor is adopted to adjust the rotation speed of the turning means 20.

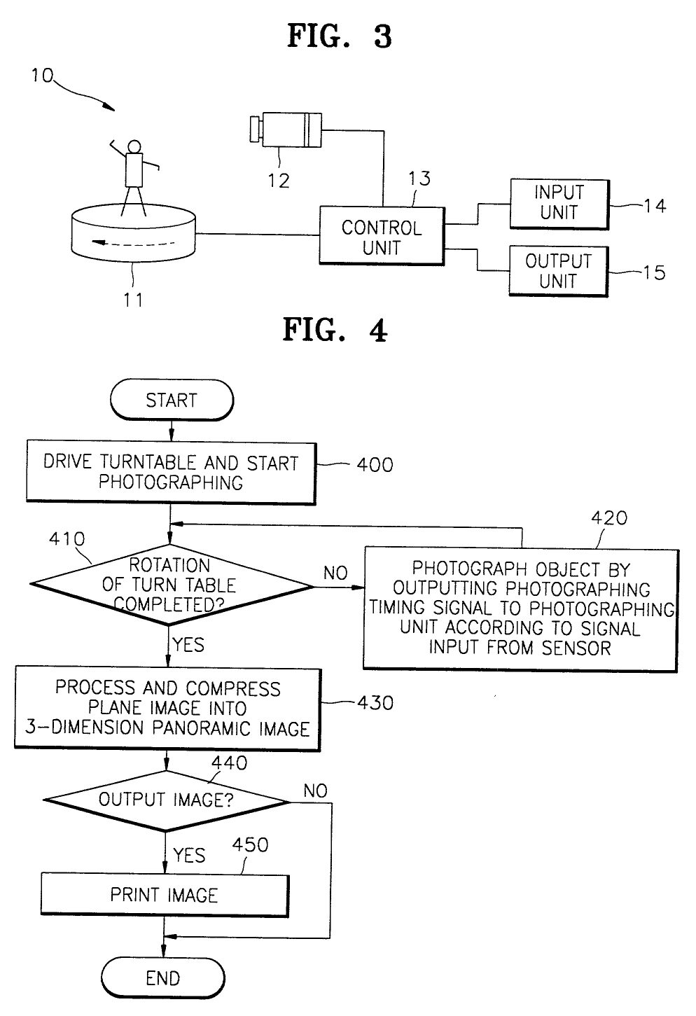

FIG. 3 is an embodiment of a three-dimensional image photographing apparatus further having an input unit 14 and an output unit 15. The identical reference numbers in FIGS. 1 and 3 represent identical elements.

Referring to FIG. 3, using a plurality of buttons, including a mode selection button, cursor move button, and selection button, which are on the input unit 14, a user can button to start photographing, or can set a photographing mode, including a three-dimensional image, a still image, and a photographing angle, and the rotation number of the turning means. Using the buttons on the input unit 14 before photographing, the user sets a photographing mode, including a still image, a three-dimensional image, and a photographing angle. A demonstration image corresponding to the photographing mode selected by the user is output on the output unit 15. Also, it is preferable that the user can set a rotation number of the turning means using the buttons on the input unit 14. When the user does not set the rotation number, the default value of the rotation number is set to “1”. If the user sets the rotation number of the turning means to “2”, seventy-two plane images will be taken and, in this case, two three-dimensional images are generated.

Meanwhile, the output unit 15 includes a monitor as a device to output photographing modes which the user can select, including photographed plane images, or three-dimensional images. Also, the output unit 15 can include a photo sticker printer which outputs photographed plane images or three-dimensional images in the form of a sticker.

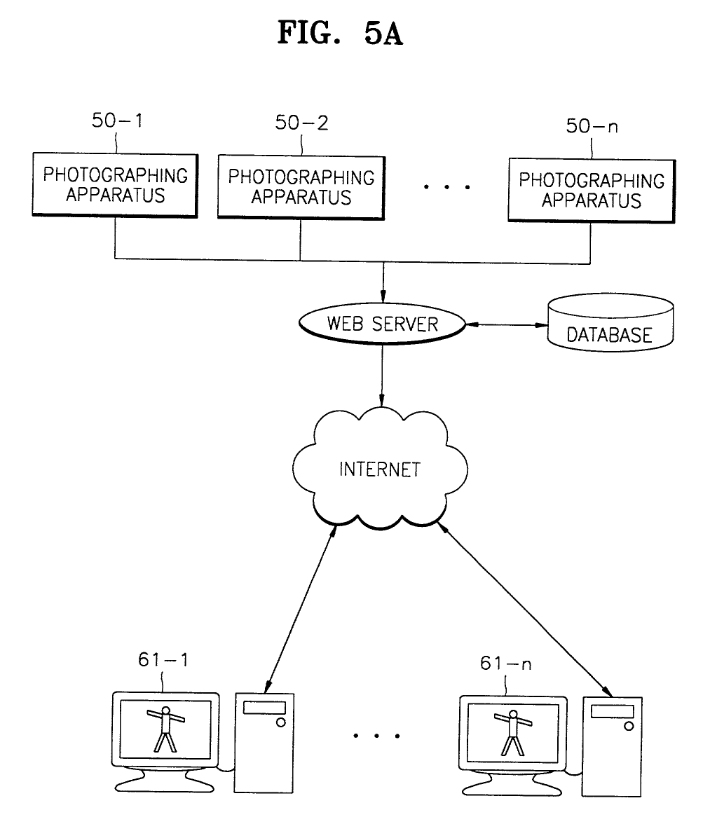

FIG. 4 is a flowchart for showing the operation of an embodiment of the photographing apparatus for a three-dimensional image.

Referring to FIG. 4, with a user buttoning to start photographing, the turning means 11 begins to rotate in step 400, and the control unit 13 checks whether or not the turning means makes a predetermined number of rotations in step 410. When the turning means 11 has not made the predetermined number of rotations and a detecting signal from the sensor is input to the control unit 13, the control unit 13 outputs a photographing timing signal to the photographing unit 12, and the photographing unit 12 photographs the object at each predetermined angle in step 420. If the turning means makes the predetermined number of rotations, photographing is finished, and the control unit 13 processes the plurality of plane images photographed by the photographing unit 12 into a three-dimensional image, and compresses the three-dimensional image in step 430. Meanwhile, if the user requests to print out the plane images or the three-dimensional image in step 440, the requested image is output through, for example, a photo sticker printer in step 450.

The control unit 13 of the photographing apparatus for a three-dimensional image can be made in the form of a board which is inserted to each slot of a computer main board, or can be implemented in software.

Referring to the attached drawings, a preferable embodiment of an image service system through communications networks according to the present invention will now be explained in detail. In the following embodiment, a case in which a three-dimensional image is transmitted through the Internet will be explained. The image service system according to the present invention can be implemented using a public switched telephone network or wireless communication network.

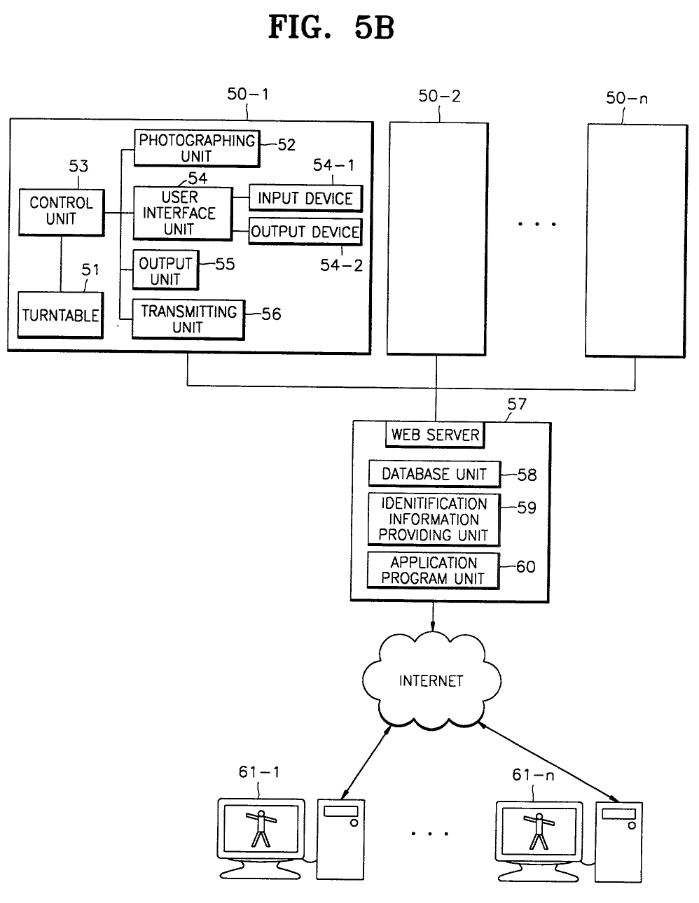

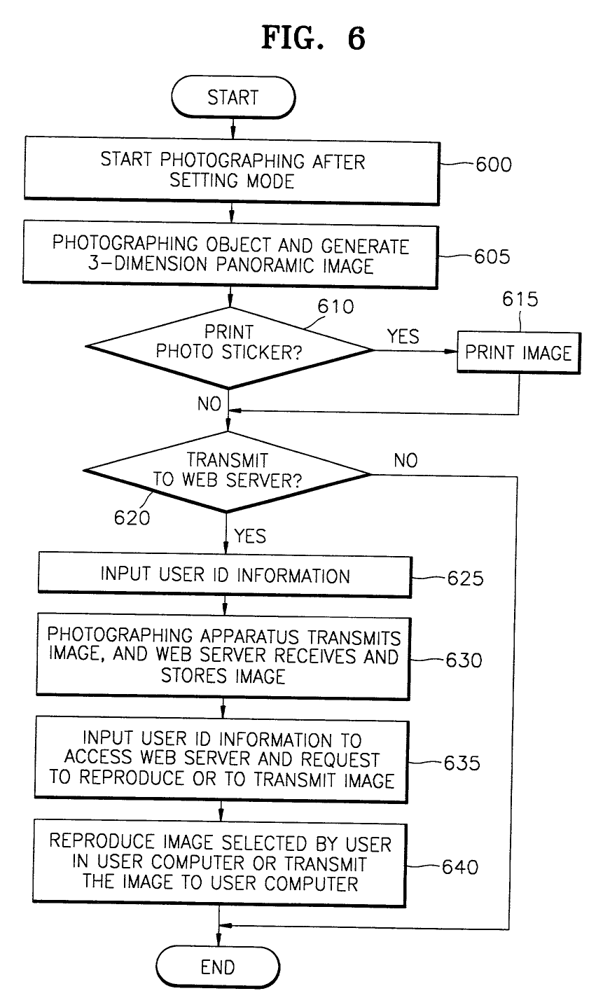

FIG. 5A is the structure of an image service system through communications networks according to the present invention, FIG. 5B is a detailed structure of the image service system through communications networks according to the present invention, and FIG. 6 is a flowchart for showing the operation of an embodiment of the image service system through communications networks according to the present invention.

Referring to FIGS. 5A through 6, the image service system through communications networks will be explained in detail. The identical reference numbers in FIGS. 5A and 5B represents identical elements.

The image service system through communications networks, which is formed with the photographing apparatuses for a three-dimensional image described above, has one or more image photographing apparatuses 50-1 through 50-n, each of which generates a three-dimensional image by photographing an object at each predetermined angle, adds user identification information to the generated three-dimensional image, and then transmits the image to a web server. The web server 57 which receives the three-dimensional images generated by the photographing apparatuses, and identification information or electronic mail (E-mail) address input by a user, stores the received data in a database, and then transmits a three-dimensional image to the E-mail address of the user, or when the user requests to watch the three-dimensional image, outputs the stored three-dimensional image corresponding to the user identification information of the user, to user computers 611 through 61-n.

Each of the image photographing apparatuses 50-1 through 50-n has a turntable 51 having a sensor for detecting the rotation state by angle and outputting a signal at predetermined angles; a photographing unit 52 for photographing an object according to a predetermined photographing timing signal; a control unit 53 for making the photographing unit photograph the object by generating a photographing timing signal according to the output signal of the sensor or at each predetermined time interval, and for finishing photographing by stopping the turntable 51 if the turntable makes a predetermined number of rotations; a user interface unit 54 which outputs photographing modes, including a three-dimensional image, still image, and photographing angle, the output types of photographed images, demonstration images corresponding to the photographing mode or the output types of the photographed image, respectively, and receives user selection in the photographing modes or the output types of photographed images, the rotation number of the turning means, and a user identification information, or user's E-mail address; an output unit 55 for printing photographed images; and a transmitting unit 56 for transmitting the photographed images to the web server or user's e-mail address.

The web server 57 has a database unit 58 for storing three-dimensional images transmitted from the photographing apparatuses for a three-dimensional image, and user identification information; an identification information providing unit 59 for providing a proper user identification information if a user does not input a user identification information; and an application program unit 60 for outputting three-dimensional images stored in the database unit to the user computers 61-1 through 61-n at the request of a user who inputs user identification information after accessing the web server.

A user inputs the photographing mode, the output type of photographed images, and the rotation number of the turntable through the input device 54-1 of the user interface unit 54 and commands the photographing apparatus to start photographing in step 600.

If a photographing start signal is output from the control unit 53, the turntable 51 starts to rotate, the photographing unit 52 photographs an image of each predetermined angle according to a signal of the sensor installed in the turntable 51, and then a three-dimensional image of the object is generated in step 605. The steps from the start of photographing to the generation of a three-dimensional image are the same as those described above, and therefore detailed explanation will be omitted.

Meanwhile, the user can input his E-mail address or proper user identification information through the input device 54-1 of the user interface 54 in step 625. Preferably, the user identification information can be used as a membership number of a company which manages the image service system through communications networks, and if the user does not directly input user identification information, the identification information providing unit 60 automatically provides proper user identification information. In this case, the user keeps user identification information displayed on the output device 54-2 of the user interface unit 54 in mind, and uses the information later when the user accesses the web server 57 to obtain his three-dimensional images. Also preferably, the identification information providing unit 59 provides a proper apparatus identification number to each image photographing apparatus, and has a function for providing a proper image identification number to each photographed image of each photographing apparatus. This apparatus identification number and image identification are attached to user identification information.

Preferably, the output unit 55 is a photo sticker printer, and the user can determine whether or not to print a photographed image using the photo sticker printer in step 610. Preferably, if the user selects to print the image, the user can select the size of the image to be printed and the number of prints through the input device 54-1 of the user interface 54, and can check the printed image in advance in step 615.

The image photographing apparatus 50-1 through 50-n transmits a compressed three-dimensional image and user identification information corresponding to the compressed three-dimensional image to the user e-mail address input by the user or to the web server 57 in step 630.

Meanwhile, the user can photograph an image with a desired form, using selection buttons installed in the input device 54-1 of the user interface unit 54. On the output device 54-2 of the user interface unit 54, a plurality of photographing modes which the user can select are displayed, and if the user selects a desired photographing mode using selection buttons, a demonstration image of the corresponding photographing mode is displayed. At this time, the input device 54-1 of the user interface unit 54 can be such input devices as a joystick or keyboard in addition to selection buttons, and the output device 54-2 of the user interface unit 54 can be a monitor. In this case also, preferably, the user can set the rotation number of the turntable 51. The operation of the image photographing apparatus 50-1 through 50-n according to the rotation number set by the user is described above and therefore, the explanation will be omitted. Also preferably, a variable speed motor is adopted so as to adjust the rotation speed of the turntable 51.

The web server 57 records three-dimensional images and user identification information transmitted from image photographing apparatuses 50-1 through 50-n in the database unit 58, and outputs three-dimensional images recorded in the database unit to the user computers 61-1 through 61-n at the request of the user who accesses the web server 57 and inputs user identification number.

The user who reproduces or receives his three-dimensional image stored in the web server 57 accesses the web server 57, inputs user identification information, searches three-dimensional images stored in the web server 57, and selects the image which is desired to reproduce or receive in step 635. Preferably, at this time, the web server 57 displays images corresponding to the user identification number input by the user, in an arrangement according to a predetermined sequence, on the user's monitor. If the user selects one image that he wishes to reproduce or receive, among the images displayed on the monitor, the web server 57 reproduces the image in the user computer 61-1 through 61-n, using a virtual reality reproducing program installed in the application program unit 60, or transmits the image to the user computer in step 640. At this time, the user can enlarge, decrease, or rotate the image reproduced in the user computer 61-1 through 61-n, using the mouse, so as to display the image in the desired form.

Meanwhile, it is preferable that the user can open a shopping mall in the web server 57. In this case, the user can select opening of a shopping mall, using the buttons on the input device 54-1 installed in the user interface unit 54 of the image photographing apparatus 50-1 through 50-n. If the user selects the the opening of a shopping mall, the user can input product information such as desired sales prices, through the input device 54-1, and preferably this process is performed in the step 600. If the user selects the opening of a shopping mall, inputs desired sales prices, and commands to start photographing, a three-dimensional image of an object is generated through the processes described above, and transmitted to the web server 57.

If the three-dimensional image corresponding to the user who selected the opening of a shopping mall is received, the web server generates the shopping mall of the user, and the received three-dimensional image and product information input by the user are displayed in the shopping mall. Preferably, after generating the shopping mall through the above-described process, the user can access the web server 57 so as to modify the desired sales prices and input additional explanation such as product introduction. Also, this process can be applied to the opening of a self-introduction site. Preferably, in this case, the user can select the opening of a self-introduction site and input brief self-introduction such as name, fields of interest, using the selection buttons on the input device 54-1 of the user interface unit 54. This opening of a shopping mall or self-introduction site is performed in the application program unit 60 of the web server 57.

Preferably, the image service system through communications networks further includes a recording unit for recording the voice of the user, and a sound unit for attaching the user's voice or predetermined sound effect data recorded in the recording unit, to the three-dimensional image. Preferably, in this case, the recording unit is included in the user interface unit 54, and the sound unit which stores predetermined sound effect data and attaches the user's voice or sound effect data selected by the user to the three-dimensional image is included in the web server 57.

If the user wishes to add sound effect data, the user selects sound effect data menu through the user interface unit 54, and selects sound effect data which he likes, in the sound effect data menu displayed on the output unit 54-2 such as a monitor. The web server 57 makes the user hear the sound effect data selected by the user through the user interface unit 54, and if the user finally selects sound effect data, then attaches the sound effect data to the three-dimensional image corresponding to the user.

The image service system through communications networks according to the present invention can be manufactured in diverse forms, and can adopt a photographing apparatus which performs the same functions as the image photographing apparatus described above.

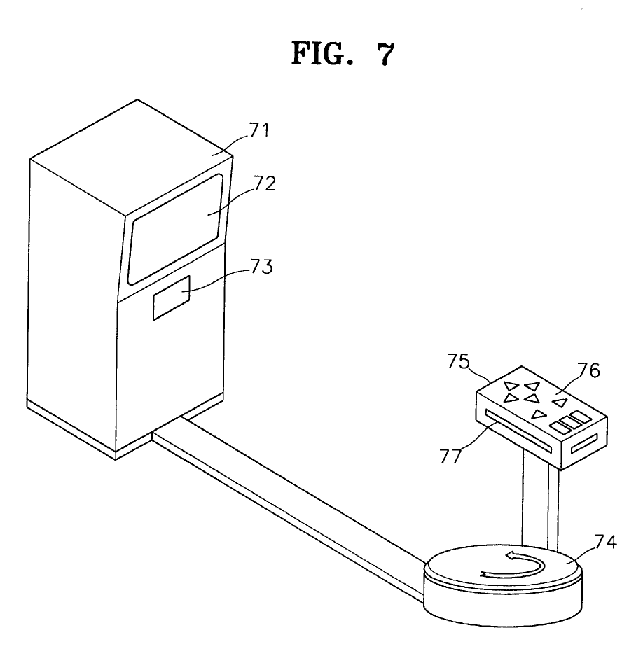

FIG. 7 illustrates an embodiment of the image photographing apparatus of the image service system through communications networks according to the present invention. The image photographing apparatus 70 shown in FIG. 7 has a photographing unit 73, a control unit (not shown), the output device 72 of the user interface unit, and a transmitting unit (not shown) in one case 71, and an input device 76 of the user interface unit, the input device which is formed of a plurality of buttons and output device 77, in a separate case 75 installed near the turntable 74. The input device 76 of the user interface unit in FIG. 7 is formed of a plurality of buttons, and preferably includes a move button, mode selection button, and selection button.

FIG. 7 is an embodiment of the image photographing apparatus of the image service system through communications networks shown in FIGS. 5A and 5B, and the functions of parts are the same as those explained referring to FIGS. 5A and 5B.

Preferably, the image photographing devices of the image service system through communications networks according to the Internet are placed at one or more locations and connected to the web server through communications networks.

Optimum embodiments are explained in the drawings and specification, and though specific terminologies are used here, those were only to explain the present invention. Therefore, the present invention is not restricted to the above-described embodiments and many variations are possible within the spirit and scope of the present invention. The scope of the present invention is not determined by the description but by the accompanying claims.

According to the photographing apparatus for a three-dimensional image of the present invention, a user can easily photograph a three-dimensional image and output the photographed image in the form of a photo sticker. Also, according to the image service system using the photographing apparatus for a three-dimensional image through communications networks, a user can photograph a three-dimensional image using photographing apparatuses placed on one or more locations, and particularly, since the image photographed at each photographing location by the user is automatically transmitted to and managed in the web server, the user can receive his three-dimensional image any where any time.

What is claimed is:

1. A photographing apparatus for a three-dimensional image, comprising:
a turning means for turning an object thereon, detecting the rotation state of the turning means by angle and outputting a signal at each predetermined angle;
a control unit for outputting a photographing timing signal and finishing the photographing if a predetermined number of output signals from the turning means are received; and
a photographing means for photographing the object according to the photographing timing signal.

2. The photographing apparatus of claim 1, wherein the turning means comprises a sensing means for sensing the rotation state of the turning means by angle.

3. The photographing apparatus of claim 1, further comprising:
an input means for inputting photographing modes, including a tilt, and the number of rotation of the turning means; and
an output means for outputting one or more three-dimensional images for demonstration corresponding to a photographing mode and the rotation number selected by the input means.

4. The photographing apparatus of claim 3, wherein the output means further comprises a means for printing photographed images.

5. The photographing apparatus of claim 1, wherein the turning means comprises:
a sensor plate having a plurality of holes, which are formed at predetermined intervals, on its side surface;
a rotation plate which is fixed to the sensor plate and rotates according to the rotation of the sensor plate; and
a sensor which is spatially separated from the sensor plate and outputs a detecting signal by detecting a hole of the sensor plate.

6. The photographing apparatus of claim 1, wherein the control unit includes an image processing unit for processing a three-dimensional image by linking a plurality of plane images photographed by angle.

7. An image service system through communications networks comprising:
one or more image photographing means, each of which generates a three-dimensional image by photographing an object at predetermined angles, adds user identification information to the generated three-dimensional image, and then transmits the image; and
an operating means for receiving the three-dimensional image and identification information generated by the photographing means, storing the received data in a database, and if a user requests the three-dimensional image, outputting the stored three-dimensional image corresponding to a user identification information, to the user computer through the communications networks.

8. The image service system of claim 7, wherein the image photographing means comprises:
a turning means for turning an object thereon, detecting the rotation state of the turning means by angle and outputting a signal at each predetermined angle;
a control unit for outputting a photographing timing signal and finishing the photographing if a predetermined number of output signals from the turning means are received; and
a photographing means for photographing the object according to the photographing timing signal.

9. The image service system of claim 8, wherein the turning means comprises a sensing means for sensing the rotation state of the turning means by angle.

10. The image service system of claim 8, wherein the turning means comprises:
a sensor plate having a plurality of holes, which are formed at predetermined intervals, on its side surface;
a rotation plate which is fixed to the sensor plate and rotates according to the rotation of the sensor plate; and
a sensor which is spatially separated from the sensor plate and outputs a detecting signal by detecting a hole of the sensor plate.

11. The image service system of claim 8, further comprising:
an input means for inputting photographing modes, including a tilt, and the number of rotation of the turning means; and
an output means for outputting one or more three-dimensional images for demonstration corresponding to a photographing mode and the rotation number selected by the input means.

12. The image service system of claim 8, wherein the output means further comprises a means for printing photographed images.

13. The image service system of claim 8, wherein the control unit includes an image processing unit for processing a three-dimensional image by linking a plurality of plane images photographed by angle.

14. The image service system of claim 7, wherein if the user selects an opening of a shopping mall or a self-introduction site, a shopping mall or a self-introduction site, in which three-dimensional images transmitted through the image photographing means, product information input by the user, and/or a self introduction are displayed, is generated in the operating means.

15. The image service system of claim 7, wherein the operating means comprises:
an identification information providing unit for providing proper user identification information if a user does not input user identification information; and
an application program unit for outputting three-dimensional images, corresponding to the user to the user terminal at the request of the user who inputs user identification information after accessing the operating means.

16. The image service system of claim 7, further comprising:
a recording means for recording the voice of the user; and
a sound unit for attaching the user's voice or predetermined sound effect data recorded in the recording means, to the three-dimensional image.

17. A photographing method for photographing a three-dimensional image, the photographing method comprising the steps of:
(a) detecting angle representing means including holes formed at predetermined intervals on a turning means;
(b) photographing an object rotating by the turning means, by generating a photographing timing signal when the angle representing means is detected; and
(c) converting the plurality of plane images photographed by angles into a three-dimensional image by linking the plurality of plane images.

18. An image service method through communications networks, the method comprising the steps of:
(a) generating a plurality of plane images by photographing by angle an object rotating by a rotating means, and converting the generated plurality of images into a three-dimensional image by combining the plurality of images;
(b) attaching user identification information to the three-dimensional image and transmitting the image to an operating means through communications networks; and
(c) reproducing the three-dimensional image in the user terminal or transmitting the three-dimensional image to the user terminal, where the user who inputs a user identification number and then accesses the operating means requests reproduction or transmission of the three-dimensional image corresponding to the user identification number.

19. The image service method of claim 18, wherein in the step (a), a plurality of plane images are generated by photographing the rotating object at ten-degree increments of rotation.

20. The image service method of claim 18, wherein in the step (b), if the user does not input the user identification number, the operating means provides a proper user identification number.

21. The image service method of claim 18, wherein if the user selects the opening of a shopping mall or a self-introduction site, a shopping mall or a self-introduction site, in which three-dimensional images received by the operating means in the step (b), product information input by the user, and/or a self introduction are displayed, is generated in the operating means.
